(19) United States
(12) Patent Application Publication
(10) Pub. No.: US 2008/0109998 A1
(43) Pub. Date: May 15, 2008

(54) SAFETY HANDLES FOR INDUSTRIAL CUTTING EQUIPMENT

(76) Inventor: Richard John Harold Graff, Brampton (CA)

Correspondence Address: BERESKIN AND PARR, 40 KING STREET WEST, BOX 401, TORONTO, ON, M5H 3Y2, omitted

(21) Appl. No.: 11/938,567

(22) Filed: Nov. 12, 2007

Related U.S. Application Data
(60) Provisional application No. 60/865,177, filed on Nov. 10, 2006.

(51) Int. Cl. B25G 1/10

(52) U.S. Cl. 16/436

(57) ABSTRACT

A safety handle for use with industrial cutting equipment is disclosed. The safety handle includes a structural member, an insulating core encasing the structural member for impeding flow of electricity to an operator, a stop ring abutting the insulating core, and a slip-resistant, vibration absorbing grip layer sheathing the insulating core.

### PRIORITY

This application claims the benefit of U.S. Provisional Patent Application No. 60/865,177 filed Nov. 10, 2006.

### FIELD

The present invention generally relates to handles for industrial equipment. More particularly, the present invention relates to safety handles for use with industrial cutting equipment, e.g., for cutting concrete and asphalt.

### BACKGROUND

The following paragraphs are not an admission that anything discussed in them is prior art or part of the knowledge of persons skilled in the art.

The use of industrial equipment for cutting concrete or asphalt is well known. For example, a common method for cutting concrete or asphalt involves using a concrete saw to cut horizontal concrete surfaces, such as roads, floors, bridges, and the like. Concrete road saws, sometimes referred to as “slab saws” or “flat saws”, generally feature a steel blade having diamond bits or segments that are placed around the periphery of the blade. The blade is spun at high speeds by a motor, and the diamond bits or segments abrade the material to be cut upon contact. The motor also typically propels a drive mechanism, although machines having no drive mean also exist. The motor and blade arrangement is usually mounted within a walk-behind machine and controlled by an operator. These concrete saws are typically used for cutting concrete and asphalt, for example, trenching applications for utilities or foundations, and can be either gas or electric powered.

Core drilling is another well-known method for cutting concrete. In this case, a drilling motor is equipped with an annular diamond-tipped drill bit. The motor is supported along a track system that allows the operator to descend the bit into the concrete surface to produce precise round openings, e.g., for drains, HVAC, plumbing, electrical, cable, phone, fiber optic, handrails, etc. Wall sawing is another common method used for cutting concrete. Wall saws employ a similar diamond blade that is implemented on a track system used for creating substantially straight cuts in a wall or floor. This cutting method is often used to cut precise openings for doors, windows, and other similar applications. Other common methods of cutting concrete using industrial equipment are known and are apparent to a person of skill in the art.

However, operating equipment in this manner may be generally dangerous because an operator of the equipment may strike an electric power line or conduit buried beneath the surface of the concrete. Unfortunately, electrocution remains a significant cause of death in the construction industry. Safeguards, such as attempts to locate and mark all buried or embedded services prior to cutting, or reviewing plans and drawings to indicate underground lines or lines that are otherwise structurally embedded, are generally not fool-proof.

It should be understood that the risk of electrocution generally stems from two electrical sources: unknown structurally embedded electrified objects and the equipment itself being electrical. With respect to the later, there can be an increased risk if the operator is working in a wet environment, which is often the case in concrete cutting situations because water is used as a coolant and carries away the material cuttings in the form of slurry.

Industrial cutting and coring equipment typically features simple steel rods as handles. For example, slab saw machines may have two 1″ round steel handlebars that are generally horizontal and spaced apart for the operator to hold with both hands, parallel to the direction of cutting. On smaller machines, the handle may be a single horizontal steel bar perpendicular to the direction of cutting with grip areas on either end of the bar. Core drills typically are equipped with either a “slider” handle or a “four poster” handle used to turn the crank to move the motor along the track. Wall saws typically have a steel crank bar.

Unfortunately, steel rod or bar handles in general are good conductors and do not offer protection to the operator from electrocution, whether from buried hazards or otherwise. Further, steel rod or bar handles may provide a slippery surface for the operator to grip, especially in wet conditions. Further still, rod or bar handles typically present a hard surface and do little by way of shock or vibration absorption, which may contribute to operator fatigue and repetitive stress injuries such as Carpal tunnel syndrome.

### SUMMARY

The following introduction is intended to introduce the reader to this specification but not to define any invention. One or more inventions may reside in a combination or sub-combination of the apparatus elements or method steps described below or in other parts of this document. The inventor does not waive or disclaim his rights to any invention or inventions disclosed in this specification merely by not describing such other invention or inventions in the claims.

In accordance with an aspect of the present invention, a safety handle for industrial cutting equipment is provided, the safety handle comprising: a longitudinal structural member comprising first and second ends; an insulating core encasing the structural member from the first end to an intermediate position between the first and second ends; a stop ring secured to the structural member at the intermediate position, the stop ring abutting the insulating core at the intermediate position; and a grip layer sheathing the insulating core.

The insulating core may include a cylindrical tube defining a hollow interior, with the structural member disposed within the hollow interior. An outer radius of the stop ring may be at least equal to an outer radius of the insulating core in size. The hollow interior of the insulating core may have an open end and a closed end, with the first end of the structural member abutting the closed end. Or, alternatively, an insulating end cap may be provided adjacent to the first end at least partially within the hollow interior of the insulating core, and the grip layer may include an end portion that covers the end cap. Or, also alternatively, an insulating end plug may be provided adjacent to the first end at least partially within the hollow interior of the insulating core, and the grip layer may include an end portion that covers the end plug.

The insulating core may be secured to the structural member, using an adhesive product, for example. The insulating core may be formed of fiberglass, nylon or PVC material. The structural member may be a steel rod. The stop ring may be secured to the structural member by welding, or the stop ring may be secured to the structural member by at least one set screw. The grip layer may be formed of a slip-resistant material and/or a vibration absorbing material, such as plastic or rubber.

In accordance with another aspect of the present invention, a safety handle is provided comprising: a steel rod comprising first and second ends; an insulating core comprising a cylindrical tube defining a hollow interior, the steel rod disposed within the hollow interior encasing the steel rod from the first end to an intermediate position between the first and second ends; a stop ring secured to the steel rod at the intermediate position, the stop ring abutting the insulating core, an outer radius of the stop ring being at least equal to an outer radius of the insulating core in size; and a grip layer sheathing the insulating core. The insulating core may be formed of fiberglass, nylon or PVC material. The grip layer may be formed of plastic or rubber.

### BRIEF DESCRIPTION OF THE DRAWINGS

For a better understanding of the present invention and to show more clearly how it may be carried into effect, reference will now be made, by way of example, to the accompanying drawings which show, by way of example, one or more embodiments of the present invention and in which:

FIGS. 1A and 1B are sectional and perspective views of a safety handle in accordance with an embodiment of the present invention;

FIGS. 2A and 2B are sectional and perspective views of a safety handle in accordance with another embodiment of the present invention;

FIG. 3 is a perspective outline view of a saw machine including safety handles; and

FIG. 4 is a perspective outline view of an operator with a saw machine including safety handles.

### DETAILED DESCRIPTION

Various apparatuses or methods will be described below to provide an example of an embodiment of each claimed invention. No embodiment described below limits any claimed invention and any claimed invention may cover apparatuses or methods that are not described below. The claimed inventions are not limited to apparatuses or methods having all of the features of any one apparatus or method described below or to features common to multiple or all of the apparatuses described below. It is possible that an apparatus or method described below is not an embodiment of any claimed invention. The applicant(s), inventor(s) and/or owner(s) reserve all rights in any invention disclosed in an apparatus or method described below that is not claimed in this document and do not abandon, disclaim or dedicate to the public any such invention by its disclosure in this document.

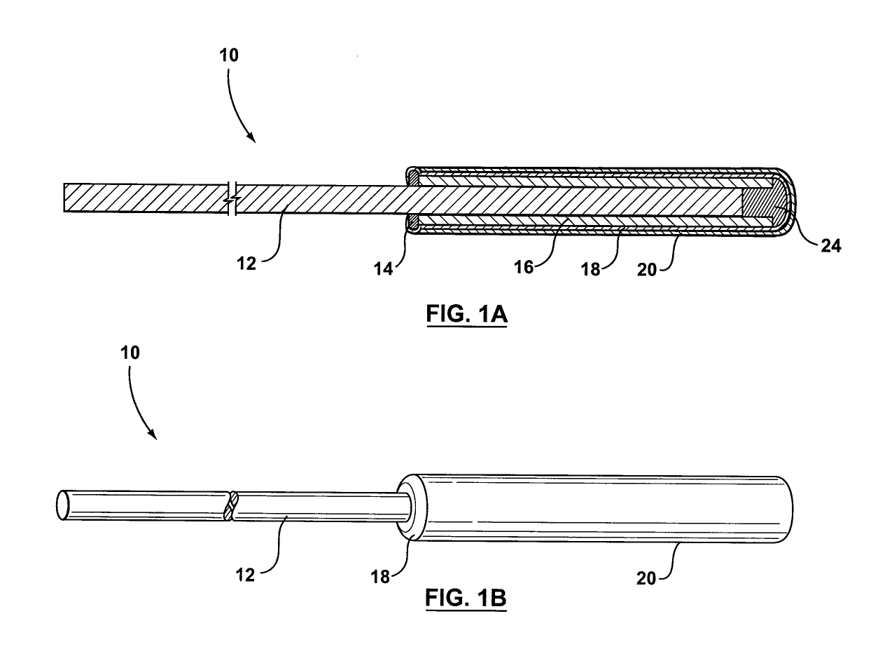

Referring to FIGS. 1A and 1B, a safety handle 10 according to one embodiment of the present invention comprises a longitudinal structural member such as a steel round bar 12 encased by an insulating core 16. The insulating core 16 is a cylindrical tube defining a hollow interior, and the structural bar 12 is provided within the hollow interior. The insulating core 16 impedes electrical current from traveling though equipment's handles to the equipment operator if a buried electrified object is struck during the concrete cutting, or, in the case of electrically-powered equipment, a malfunction of the equipment itself. The insulating core 16 can be formed of, for example, high-voltage fiberglass insulating material.

The bar 12 provides the structural rigidity of the handle 10 and is inserted into the handle opening provided in the particular industrial equipment (not shown). The insulating core 16 extends from a first end of the bar 12 to an intermediate position, e.g., approximately midway point of the bar 12. A stop ring 14 is placed at the end of the insulating core 16 at the intermediate position. The stop ring 14 is secured to the bar 12 (by welding or one or more set screws, for example) and abuts the insulating core 16 at the intermediate position. Preferably, the stop ring 14 is made of a resilient material, such as steel, for reasons that will hereinafter become apparent. It is also preferable that the stop ring 14 has a radius at least as big as the radius of the insulating core. A recess is provided between the insulating core 16 and the end of the bar 12 to allow for an end cap 24 to be disposed. Preferably, the end cap 24 is made of an insulating material to ensure that the first end of the handle 10 is fully insulated. The insulating core 16 may first be surrounded by an optional protective coating 18 such as shrink wrap material to shield and protect the insulating core 16, as well as hold the insulating core 16 snug with the stop ring 14. Further, a grip layer 20 is fitted over the protective coating 18 to shield and protect the insulating core 16 and to provide a slip-resistant and comfortable surface for the operator to grip.

In a particular example of this embodiment, the bar 12 is a 32″ steel bar that is 1″ in diameter. The stop ring 14 is steel and placed 14″ in from one end of the bar 12. The insulating core 16 is a prestressed fiberglass hollow cylindrical tube 15″ in length with an inner diameter of 1″ that is placed over the bar 12 until it abuts the stop ring 14. The insulating core 16 is secured to the bar 12 with silicone adhesive. The overlap between the insulating core 16 and the bar 12 provides a 1″ recess allowing for the insertion of a plastic end cap 24. (An example of a suitable product for the end cap 24 is model #C-40-U2 available from Caps'n Plugs, Brampton, Canada.) Rubber shrink adhesive tubing is used to cover the entire area as the protective layer 18, which protects the insulating core 16 from being crushed or dented. (An example of suitable heat shrink tubing for the protective layer 18 is model number HSPO-2000-4-L available from Techspan Industries Inc., Mississauga, Canada.)

The grip layer 20, placed overtop the protective layer 18, is formed of a durable and slip-resistant plastic or rubber material and is preferably brightly colored. The grip layer 20 provides an improved gripping surface that is durable and advantageously shields and protects the insulating core 16 from damage. In addition to slip-resistance, the grip layer 20 may also absorb shock and vibration making it more comfortable to use, improving operator fatigue and reducing onset of repetitive stress injuries. The grip layer 20 may also be providing in a bright color to improve visibility.

The stop ring 14 and the end cap 24 are important for the present invention, particularly if the insulating core 16 is fiberglass, because they prevent damage to the insulating core 16, damage that may otherwise occur during the normal wear-and-tear of the concrete cutting equipment. For example, operators are known to remove handles from a concrete saw in order to allow a machine to fit in a confined space close to a wall. The insertion and removal of the handles may impart impact forces that could damage the insulating core 16 if the forces are not absorbed by the stop ring 14 and end cap 24. For this reason, the stop ring 14 and end cap 24 are preferably made of resilient material such as a hard plastic. Steel could also be used, although it is preferable that the end cap 24 be formed of insulating material so that the first end of the handle 10 is fully insulated. The stop ring 14 should have a radius at least as big as the radius of the insulating core 16 so as to fully abut and protect the end of the insulating core at the intermediate position.

Alternative to what is shown in FIG. 1A, instead of the end cap 24, the insulating core 16 can be provided having an open end and a closed end, with the first end of the bar 12 provided abutting the closed end. Having an insulating core 16 with a closed end ensures that the first end of the handle 10 is fully insulated without having to use an end cap 24 (although it may be more costly to manufacture the insulating core 16). Having an insulating core 16 with a closed end is particularly suitable if the insulating core 32 is formed of a relatively tough material such as nylon, which does not require the impact protection of the end cap 24.

As mentioned, the grip layer 20 and the protective layer 18 provide further protection for the insulating core 16. This is especially true if the insulating core 16 is formed of rigid fiberglass materials since this material is somewhat brittle and prone to damage if there are side impacts. Preferably, the grip layer 20 is formed of a durable and slip resistant material, such as rubber or a soft plastic. As a result, the grip layer 20 layer provides soft feel that makes it easier to use and more comfortable for the operator when compared to a steel bar, thereby decreasing hand fatigue when the operator is using the equipment over a long period of time. Texture may also be provided on the grip layer 20 to enhance its slip-resistant properties. Preferably, the grip layer 20 is also provided in a bright color, such as bright yellow, for example. Yellow makes the safety handle 10 distinctive so that its use is apparent to the operator and other workers alike. Bright yellow also makes the safety handle 10 more visible to the operator if operating the equipment in low-light conditions.

Although fiberglass is mentioned as a suitable non-conductive material for the insulating core 16, it should be understood that other materials that may be used, such as nylon or PVC, as long as these materials are operable to insulate against electric shock.

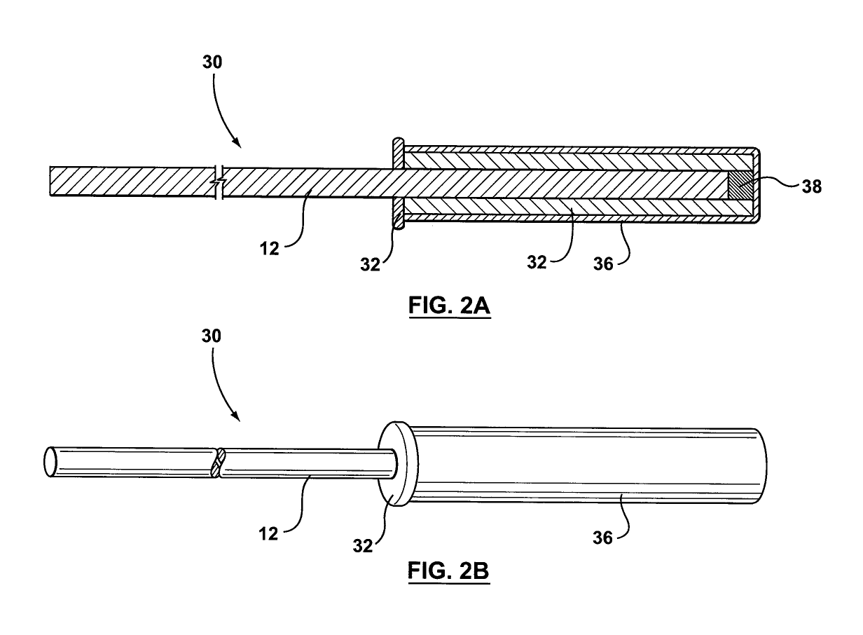

Referring to FIGS. 2A and 2B, a safety handle 30 according to another embodiment of the present invention also comprises a longitudinal structural member such as a steel round bar 12 encased by an insulating core 32, in this case, a nylon tube. A stop ring 32 and grip layer 36 are provided. In this case, an end plug 38 is provided in place of the end cap 24. The end plug 38 is formed of an insulating material.

Safety handle 30 may have similar dimensions to handle 10. For example, the bar 12 is a 32″ steel bar that is 1″ in diameter. The stop ring 32 is steel with having 1½″ radius and placed 14″ in from a first end of the bar 12. The insulating core 32 is a hollow cylindrical nylon tube 15″ in length with an inner diameter of 1″ and outer diameter of 1½″ that is placed over the bar 12 until it abuts the stop ring 32. The insulating core 32 is secured to the bar 12 with silicone adhesive. A 1″×1″ end plug 38, also formed of nylon, is provided. The grip layer 36 is a thermoplastic material and includes an end portion covering the end plug 38.

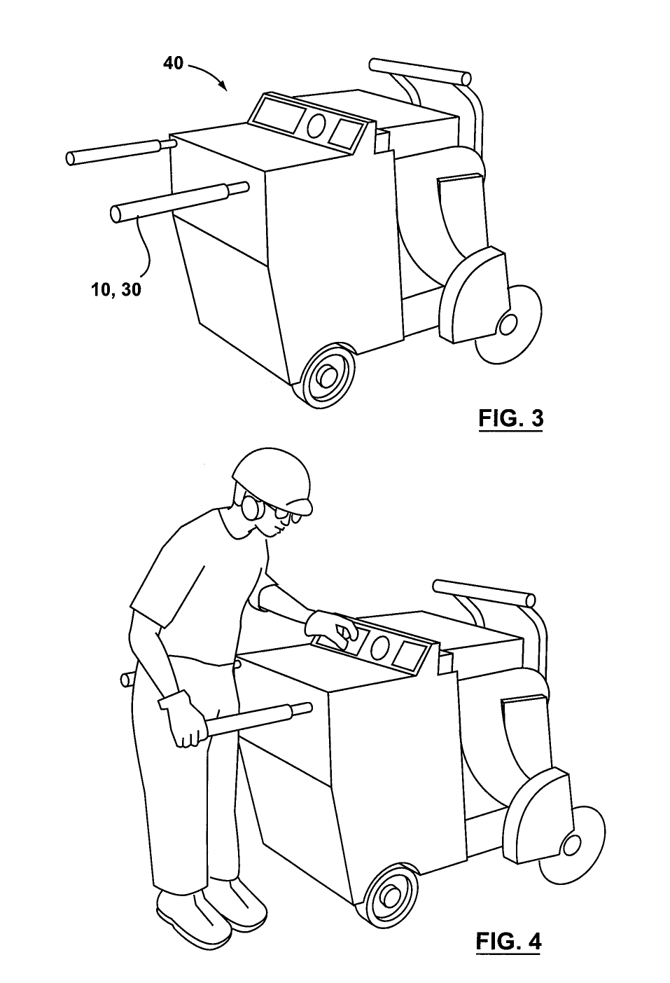

FIG. 3 shows the safety handles 10, 30 of the present invention implemented with a road saw 40. Advantageously, the safety handles 10, 30 are easy to install and require no modifications of the sawing equipment, since most commercially available industrial cutting/coring equipment utilize steel bar handles of standard size, e.g., 1″ diameter. All that is required for the installation of the present invention for road saws is that the operator removes the steel handles, typically held in place by a bolt that is tightened radially against the handle, and insert the safety handle.

Although the dimensions for the safety handles 10, 30 discussed above are appropriate for use with many commercially-available road saws, the present invention is adaptable to various handle sizes and shapes. In other words, although the embodiments described above relate to a road saw handle, it should be expressly understood that the present invention can be implemented to provide safety handles for various other industrial equipment, including handles for small saw machines, insulated safety cranks for wall saws, core drill slider handles, core drill four poster handles, etc. With these different sized handle applications, it should be understood that a structural member is not essential, depending on the insulating material used and the dimensions of the handle. For example, nylon is sufficiently structurally rigid, such that a 1¼″ nylon round bar could be used as an insulating core for a slider handle with no steel rod required. Other embodiments are of course possible, either with structural members such as a steel rod, or without a structural member. In order to ensure of the insulating efficacy of a particular handle configuration, dielectric tests can be carried out by attaching, e.g., 35 kVA on the metal end and checking for leakage on the insulated end, in a manner that is known.

FIG. 4 shows an operator in position with a road saw including the safety handles of the present invention. The safety handles provide an additional layer of protection for the modern concrete cutting worker. Preferably, operators of cutting and coring equipment will use these handles along with other known safety techniques, such as the implementation of insulated boots and/or insulated gloves, for example, as a means of reducing the risk of electrical accidents in the course of using such equipment.

It should be appreciated that the spirit of the present invention is concerned with shielding equipment operators from electrical shock, such as in the event that cutting apparatus strikes an electrified buried object. The present invention is also concerned with providing a handle having an improved gripping surface for the operator. The type and structure of the industrial cutting equipment may vary, as the present invention is applicable to various types of industrial cutting or coring equipment, such as road saws, core drills, wall saws, and the like.

It is anticipated that those having ordinary skill in this art can make various modification to the embodiment disclosed herein after learning the teaching of the present invention. However, these modifications should be considered to fall under the protection scope of the invention as defined in the following claims.

1. A safety handle for industrial cutting equipment, the safety handle comprising:
a) a longitudinal structural member comprising first and second ends;
b) an insulating core encasing the structural member from the first end to an intermediate position between the first and second ends;
c) a stop ring secured to the structural member at the intermediate position, the stop ring abutting the insulating core at the intermediate position; and
d) a grip layer sheathing the insulating core.

2. The safety handle of claim 1, wherein the insulating core comprises a cylindrical tube defining a hollow interior, the structural member disposed within the hollow interior.

3. The safety handle of claim 2, wherein an outer radius of the stop ring is at least equal to an outer radius of the insulating core in size.

4. The safety handle of claim 2, wherein the hollow interior of the insulating core has an open end and a closed end, the first end of the structural member abutting the closed end.

5. The safety handle of claim 2, further comprising an end cap provided adjacent to the first end, the end cap disposed at least partially within the hollow interior of the insulating core, wherein the end cap is formed of insulating material.

6. The safety handle of claim 5, wherein the grip layer comprises an end portion that covers the end cap.

7. The safety handle of claim 2, further comprising an end plug provided adjacent to the first end, the end plug disposed at least partially within the hollow interior of the insulating core, wherein the end plug is formed of insulating material.

8. The safety handle of claim 7, wherein the grip layer comprises an end portion that covers the end plug.

9. The safety handle of claim 1, wherein the insulating core is secured to the structural member.

10. The safety handle of claim 9, wherein the insulating core is secured to the structural member using an adhesive product.

11. The safety handle of claim 1, wherein the insulating core is formed of fiberglass, nylon or PVC material.

12. The safety handle of claim 1, wherein the structural member is a steel rod.

13. The safety handle of claim 12, wherein the stop ring is secured to the structural member by welding.

14. The safety handle of claim 1, wherein the stop ring is secured to the structural member by at least one set screw.

15. The safety handle of claim 1, wherein the grip layer is formed of a slip-resistant material.

16. The safety handle of claim 1, wherein the grip layer is formed of a vibration absorbing material.

17. The safety handle of claim 1, wherein the grip layer is formed of plastic or rubber.

18. A safety handle comprising:
a) a steel rod comprising first and second ends;
b) an insulating core comprising a cylindrical tube defining a hollow interior, the steel rod disposed within the hollow interior encasing the steel rod from the first end to an intermediate position between the first and second ends;
c) a stop ring secured to the steel rod at the intermediate position, the stop ring abutting the insulating core, an outer radius of the stop ring being at least equal to an outer radius of the insulating core in size; and
d) a grip layer sheathing the insulating core.

19. The safety handle of claim 18, wherein the insulating core is formed of fiberglass, nylon or PVC material.

20. The safety handle of claim 19, wherein the grip layer is formed of plastic or rubber.
